(19) United States
(12) Patent Application Publication
(10) Pub. No.: US 2015/0123925 A1
(43) Pub. Date: May 7, 2015

(54) METHOD, APPARATUS, AND DEVICE FOR TOUCH SCREEN VERIFICATION

(71) Applicant: TENCENT TECHNOLOGY (SHEZHEN) COMPANY LIMITED, Shenzhen (CN)

(72) Inventors: LEI QIN, Shenzhen (CN); HONG ZHANG, Shenzhen (CN); YUNYUN HAO, Shenzhen (CN)

(73) Assignee: TENCENT TECHNOLOGY (SHENZHEN) COMPANY LIMITED

(21) Appl. No.: 14/591,069

(22) Filed: Jan. 7, 2015

Related U.S. Application Data
(63) Continuation of application No. PCT/CN2013/079302, filed on Jul. 12, 2013.

(30) Foreign Application Priority Data
Jul. 13, 2012 (CN) 2012-10243186.4

(51) Int. Cl. G06F 3/041; G06F 3/0481; G06F 3/0488

(52) U.S. Cl. CPC G06F 3/041; G06F 3/0488; G06F 3/04817; G06F 2203/04106
USPC 345/173

(57) ABSTRACT

Various embodiments provide methods, apparatus, and devices for touch screen verification (or device verification). In an exemplary method, trajectories of at least two discrete touch gestures inputted by a user can be recorded by an electronic device and compared with trajectories in a preset sequence of trajectories. A successful verification can be determined by the electronic device, when the trajectories of the inputted at least two discrete touch gestures are consistent with the trajectories in the preset sequence of trajectories.

### CROSS-REFERENCES TO RELATED APPLICATIONS

This application is a continuation of PCT Application No. PCT/CN2013/079302, filed on Jul. 12, 2013, which claims priority to Chinese Patent Application No. CN201210243186.4, filed on Jul. 13, 2012, the entire contents of all of which are incorporated herein by reference.

### FIELD OF THE DISCLOSURE

The present disclosure relates to the field of device verification and, more particularly, relates to methods, apparatus, and devices for touch screen verification.

### BACKGROUND

Electronic devices having touch screens, e.g., mobile phones, personal digital assistants (PDAs), etc., usually have a screen lock function. The screen lock function may prevent false operations when a device is not intended to be used (e.g., a false phone-dialing or a false launching of application programs), or prevent other people from viewing information on the device when the device is not in hands of the device owner.

There are mainly two methods for unlocking a device using existing technology. One method includes using a slide-to-unlock function to unlock the device. That is, according to a prompt for sliding on the device, a user may slide along a fixed trajectory direction to complete an unlock verification of the device. Such an unlock verification method is mainly intended for preventing false operations by the user, and cannot provide security protection on user information.

The other method includes inputting a password for an unlock verification. Such method may greatly improve device security. However, given the limited size of the touch screen, it is challenging to input a password. When inputting the password with a nine-button keyboard, the user needs to select needed characters among multiple characters. This provides a complicated password inputting and affects the inputting speed. In some cases, a full keyboard may be used by the user to input the needed characters. However, due to the limited size of the touch screen, the password inputting may be prone to errors.

### BRIEF SUMMARY OF THE DISCLOSURE

According to various embodiments, there is provided a device verification method. In this method, trajectories of at least two discrete touch gestures inputted by a user can be recorded by an electronic device. The recorded trajectories of the at least two discrete touch gestures can be compared by the electronic device with trajectories in a preset sequence of trajectories. A successful verification can be determined by the electronic device, when the trajectories of the inputted at least two discrete touch gestures are consistent with the trajectories in the preset sequence of trajectories.

According to various embodiments, there is also provided a device verification method having a plurality of icons (also referred to as “visible-icons”) on a touch screen of an electronic device. Trajectories of at least two discrete touch gestures inputted by a user for connecting icons can be recorded and compared with trajectories in a preset sequence of trajectories. A successful verification can be determined when the trajectories of the inputted discrete touch gestures are consistent with trajectories in the preset sequence of trajectories.

According to various embodiments, there is further provided a device verification apparatus having a plurality of icons on a touch screen of an electronic device. The device verification apparatus can include, e.g., a recording module, a comparing module, and a sending module. The recording module can be configured to record trajectories of at least two discrete touch gestures inputted by a user for connecting icons. The comparing module can be configured to compare the recorded trajectories of the discrete touch gestures for connecting icons with trajectories in a preset sequence of trajectories. The sending module can be configured to determine and send a successful verification to a system of the electronic device, when the trajectories of the inputted discrete touch gestures are consistent with the trajectories in the preset sequence of trajectories.

In this manner, a user can input multiple touch gestures, which can form many different sequences of trajectories for device verification (also referred to as touch screen verification) via various permutations and combinations. Therefore, compared with existing slide-to-unlock technology, device security can be improved. Further, compared with existing methods for inputting passwords, device verification by multiple sliding gestures according to various disclosed embodiments can be conveniently operated and less prone to errors.

Other aspects or embodiments of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the disclosure.

FIG. 1 depicts a flow diagram of an exemplary method for device verification in accordance with various disclosed embodiments;

FIG. 2 depicts a schematic of an exemplary display interface for device verification in accordance with various disclosed embodiments;

FIG. 3 depicts a flow diagram of another exemplary method for device verification in accordance with various disclosed embodiments;

FIG. 4 depicts a flow diagram of another exemplary method for device verification in accordance with various disclosed embodiments;

FIG. 5 depicts a schematic of another exemplary display interface for device verification in accordance with various disclosed embodiments;

FIG. 6 depicts a flow diagram of another exemplary method for device verification in accordance with various disclosed embodiments;

FIG. 7 depicts a flow diagram of another exemplary method for device verification in accordance with various disclosed embodiments;

FIG. 8 depicts a schematic of another exemplary display interface for device verification in accordance with various disclosed embodiments;

FIG. 9 depicts a flow diagram of another exemplary method for device verification in accordance with various disclosed embodiments;

FIG. 10 depicts a flow diagram of another exemplary method for device verification in accordance with various disclosed embodiments;

FIG. 11 depicts a structural schematic of an exemplary apparatus for device verification in accordance with various disclosed embodiments; and

FIG. 12 depicts a schematic of another exemplary display interface for device verification in accordance with various disclosed embodiments.

### DETAILED DESCRIPTION

Reference will now be made in detail to exemplary embodiments of the disclosure, which are illustrated in the accompanying drawings. Wherever possible, the same reference numbers will be used throughout the drawings to refer to the same or like parts.

In accordance with various embodiments, a password for device verification can be formed by setting a combination of multiple sliding gestures or other touch gestures. Security requirements of device verification can be achieved. A user can simply complete a verification operation by the sliding gestures with no errors easily occurring.

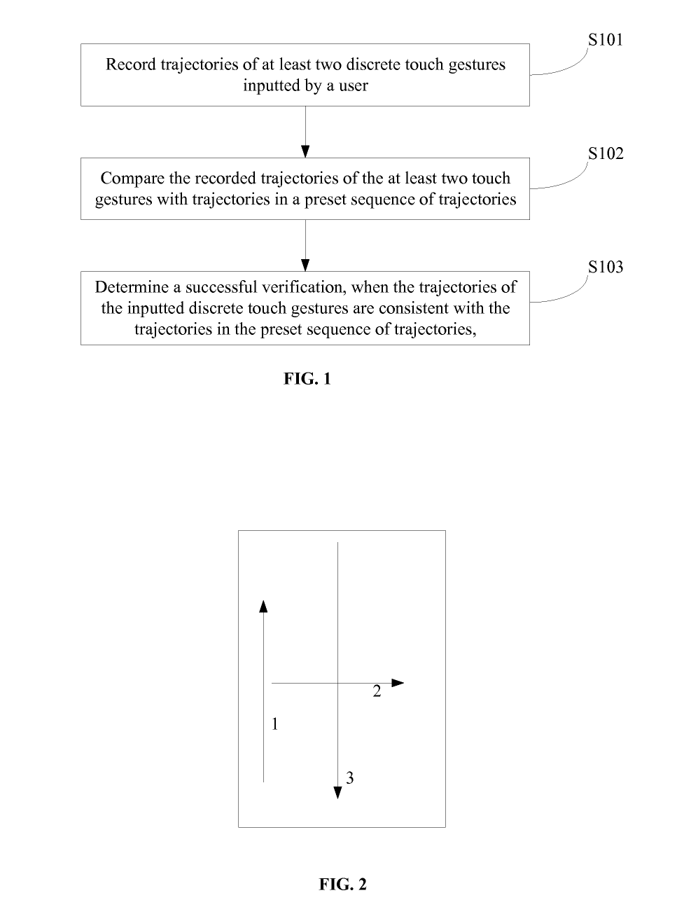

FIG. 1 depicts a flow diagram of an exemplary method for device verification in accordance with various disclosed embodiments.

In Step S101, trajectories of at least two (i.e., multiple) discrete touch gestures inputted by a user are recorded.

Electronic devices having a touch screen may include, for example, mobile phones, tablet computers, or other suitable devices with touch input. As used herein, unless otherwise specified, the term device can include an electronic device. A touch screen can be a liquid crystal display device capable of receiving inputted signals. When a pattern or an image on the screen is touched by a user, a touch feedback system on the screen can send feedback to the user according to a pre-programmed software/program.

A typical touch screen gesture operation includes the following. When a finger or other suitable object touches the screen, the touch screen system locates and verifies information inputted according to a pattern/icon or position touched by the finger or other suitable object. The touch screen may often include a touch detection apparatus and a touch screen controller. The touch detection apparatus can be installed in front of the screen, and can be used to detect and receive the position information touched by the user and send the position information to the touch screen controller. The touch screen controller can receive the information sent from the touch detection apparatus, transform the information into coordinates of point(s), and send the coordinates of point(s) to, for example, a central processing unit (CPU). The touch screen controller can also receive commands from the CPU to display on the screen. As used herein, unless otherwise specified, the term screen in this disclosure may be referred to as a touch screen.

For those electronic devices having a touch screen, a certain level of security needs to be ensured on one hand, while on the other hand, ease of user operation needs to be improved so that errors may not easily occur. The touch gestures inputted by the user can have a certain margin of error. Thus, once the user knows the position(s) and direction(s) of the touch gestures, errors can unlikely occur. Such inputting of touch gestures can be very convenient with improved user experience.

The recorded multiple discrete touch gestures inputted by the user can be arbitrarily inputted by the user, including for example a screen diagonal line, a horizontal midline, a vertical midline, etc. The touch gestures can be correspondingly inputted according to a verification sequence preset by the user. In one embodiment, for each touch gesture inputted by the user, a trajectory of the touch gesture can be recorded using a plurality of coordinate points of the touch gesture inputted by the user. Thus, requirements for inputting the gestures may be relatively strict. For example, a trajectory can be preset to include about two or three coordinate points. When a touch gesture inputted by the user reaches these two or three coordinate points, the trajectory corresponding to these coordinate points can be triggered.

In addition, for practical application considerations, a time interval can be defined between inputted gestures for each gesture. For example, the time interval between every two consecutive touch gestures can be preset to be about 1 second or any other suitable time length. During the preset time interval, the trajectory of the touch gesture inputted by the user can be received. Counting from a moment when the finger (or other suitable object) leaves the screen, when the time interval is greater than about 1 second (i.e., exceeds the preset time interval), the inputted sequence of trajectories can be considered as completed. The method can then proceed to perform Step S102.

In Step S102, the recorded trajectories of the multiple touch gestures are compared with trajectories in a preset sequence of trajectories.

For example, by repeatedly performing Step S101 for a certain number of times, a sequence of trajectories of the multiple touch gestures inputted by the user can be obtained. In one embodiment, the sequence of trajectories of the inputted touch gestures can be compared with the preset sequence of trajectories according to the sequential order of the inputting. Thus, the security of verification can be improved, and the possibility of cracking the password of the device can be reduced. Alternatively, in practical applications, there is no need to follow the sequential order of the inputting for the verification. Operation flexibility can be increased.

In one embodiment, the preset sequence of trajectories can be set by the user as desired, e.g., according to personal habits and/or hobbies. For example, positions, directions, and/or the number of touch gestures/trajectories can be preset. For security considerations, the number of touch gestures/trajectories should not be too low. When only one touch gesture is preset, it can be relatively easy to crack the password of the device, and the level of security can be low. On the other hand, the number of touch gestures/trajectories should not be too high, because too many touch gestures/trajectories can cause troublesome inputting.

In Step S103, if the trajectories of the inputted discrete touch gestures are the same as or otherwise consistent with trajectories in the preset sequence of trajectories, the verification is successful.

For example, the trajectories of the multiple touch gestures obtained in Step S101 can be compared with trajectories in the preset sequence of trajectories as depicted in Step S102. If they are the same or otherwise consistent with each other, the user is indicated legal and the verification is successful. The user is therefore allowed to access and operate the electronic device.

The comparison between the two sequences of trajectories can be configured as needed. For example, one or more coordinate points can be set to compare trajectories of touch gestures. Usually a trajectory can be denoted by setting multiple (such as two or three) coordinate points. When a touch gesture inputted by the user reaches these exemplary two coordinate points, the system of the device can verify that the trajectory of the touch gesture inputted by the user is the trajectory formed by the two coordinate points.

To avoid confusion caused by simultaneously passing multiple points, when setting the coordinate points of the trajectories, suitable distance between the coordinate points can be maintained without having the coordinate points too close to each other. In various embodiments, the sliding direction of the finger for each trajectory is not limited. For example, referring to the exemplary display interface shown in FIG. 2, for an upward sliding gesture 1, the finger can slide on the touch screen from top to bottom or from bottom to top, although an arrow is shown in FIG. 2 for the upward sliding gesture 1.

In addition to the upward sliding gesture 1 on the left side, FIG. 2 further includes exemplary touch gestures of a rightward horizontal sliding gesture 2 from the middle left, and a downward sliding gesture 3 from the middle top. The system of the electronic device can receive touch gestures inputted by the user. If an illegal user does not know the preset touch gestures/trajectories, it can be difficult to obtain the device verification by repeatedly attempting to slide.

As disclosed herein, in this example, multiple inputted gestures can be used to unlock a password for device verification. Due to diversity of combinations of gestures, the security of device verification can be ensured. In addition, sliding gestures can be used for the device verification, which is convenient for user to operate.

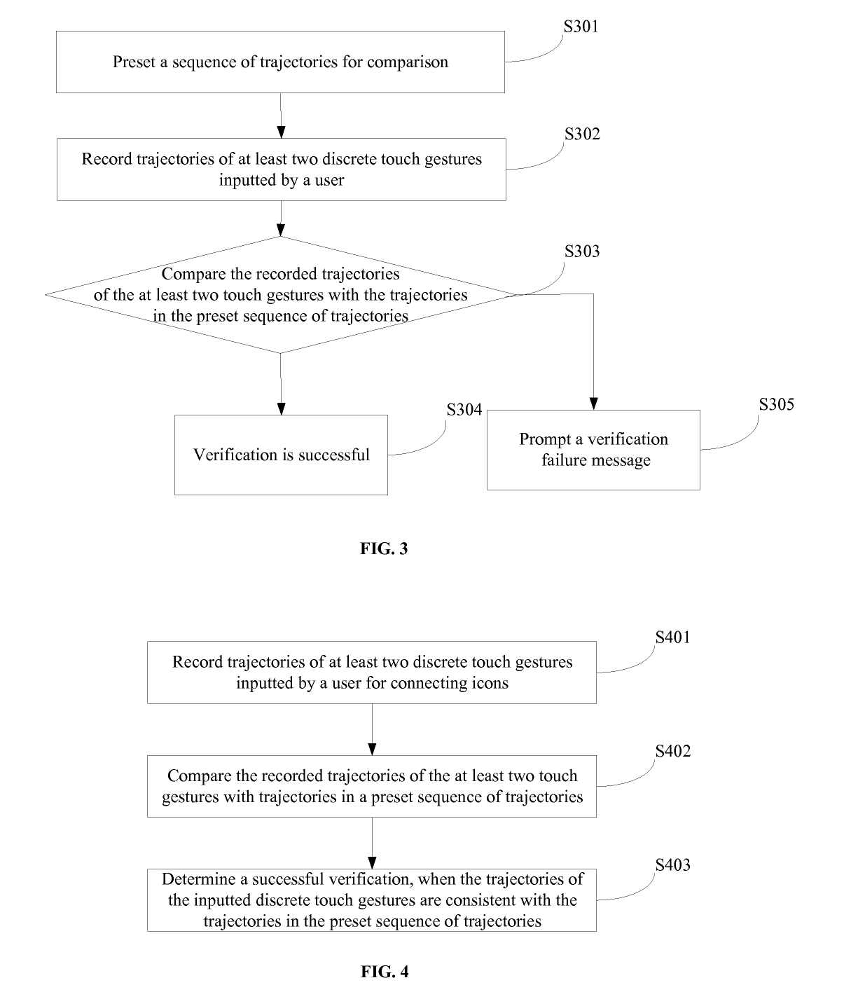

FIG. 3 depicts a flow diagram of another exemplary method for device verification in accordance with various disclosed embodiments.

In Step S301, a sequence of trajectories is preset for comparison. A user may need to verify inputted touch gestures. Therefore, for user's convenience to preset the sequence of trajectories, after entering a mode of setting the sequence of trajectories of the touch gestures for comparison, the sequence of trajectories can be preset by first sequentially inputting the touch gestures for comparison on a touch screen of a device to form the sequence of trajectories used for a subsequent comparison.

The formed sequence of trajectories can be directly stored. Alternatively, the sequence of trajectories can be repeatedly formed (e.g., once again) by sequentially inputting the touch gestures for a second time. Such sequence of trajectories can then be stored after a comparison that confirms the sequences of trajectories inputted in both (or repeated) times are consistent or the same.

In one embodiment, after the user completes inputting each touch gesture, a reproduction of the touch gesture can be shown on the screen, in order to ensure that the user can effectively memorize and confirm the touch gesture. After the inputting of one or more sequences of touch gestures is completed and confirmed, the group of sequences of touch gestures can be directly used as the sequence of trajectories formed by the touch gestures for a subsequent comparison. Alternatively, the user may need to re-input these touch gestures, according to the order, the positions, and the directions of the previous inputting, to enhance the user's impression and to avoid setting a false password by the touch gestures.

For each touch gesture, the trajectory information of the touch gestures recorded by the system of the electrical device can be a series of coordinate values. As needed, in order to reduce the burden of the system, each touch gesture can be defined in the form of, e.g., two coordinate points or other suitable number of coordinate points. When a touch gesture inputted by the user passes on such two coordinate points, it can be recognized that the user has inputted the touch gesture corresponding to the two coordinate points.

Any other suitable methods can be used to preset the sequence of trajectories of touch gestures without limitation. For example, the sequence of trajectories can also be preset by the system or by being transferred from other storage devices.

In Step S302, trajectories of at least two (i.e., multiple) discrete touch gestures inputted by a user are recorded.

In Step S303, the recorded trajectories of the multiple touch gestures are compared with trajectories in the preset sequence of trajectories.

In Step S304, if the trajectories of the inputted discrete touch gestures are the same as or otherwise consistent with trajectories in the preset sequence of trajectories, the verification is determined successful.

Steps S302-S304 can be the same as or similar to Steps S101-S103 as described above in accordance with various disclosed embodiments.

In Step S305, if the trajectories of the inputted discrete touch gestures are not the same as or not consistent with trajectories in the preset sequence of trajectories, a verification failure message can be prompted.

In one embodiment, the sequence of trajectories of the touch gestures for comparison can be preset by the user, which can thus reflect the user's personal habits and personality. This provides flexibility and convenience to the users.

FIG. 4 depicts a flow diagram of another exemplary method for device verification in accordance with various disclosed embodiments.

In one embodiment, a touch screen of a device can be provided with one or more visible-icons on the touch screen. The number of icons can be determined based on the convenience for users to operate. If there are too many visible-icons, a user may be affected during verification, which can cause false operations and affect verification efficiency. On the other hand, there should not be too few visible-icons. For example, if two icons are set, connections may be repeatedly made between the two icons, which may easily confuse the operator or cause difficulty in memorizing.

In Step S401, trajectories of at least two (i.e., multiple) discrete touch gestures inputted by a user for connecting icons on a touch screen are recorded.

In a specific embodiment, there can be multiple visible-icons on the touch screen. The user can determine the direction and position of sliding according to the icons. For example, referring to FIG. 5, there can be four icons arranged at the four corners of the touch screen, respectively. The user can connect any two of the four icons as a touch gesture. There can be many sequences of touch gestures through permutation and combination, and cannot be easily cracked by other users. In the example shown in FIG. 5, about three touch gestures can be set in sequences for verification. A first touch gesture 1 can slide from a lower right corner to an upper left corner, a second touch gesture 2 can slide from the lower left corner to the lower right corner, and a third touch gesture 3 can slide from the lower left corner to the upper right corner.

In Step S402, the recorded trajectories of the multiple touch gestures are compared with trajectories in a preset sequence of trajectories.

Corresponding to Step S401, the comparison with the preset sequence of trajectories can be based on the recorded order of passing the icons by the touch gestures and/or the recorded number of touch gestures. Because the icons can be expressed as coordinates, during the comparison, only the sequence of coordinates and the number of touch gestures need to be compared. Only when corresponding sequences of coordinates and/or corresponding number of touch gestures are completely overlapped, the comparison can be considered in consistent with each other. In some cases when a verification method is limited by an inputting order, the number of times for triggering the corresponding coordinates and the number of touch gestures can be sufficient for the comparison.

In Step S403, if the trajectories of the inputted discrete touch gestures are the same as or otherwise consistent with the trajectories in the preset sequence of trajectories, the verification is successful.

For example, after receiving a successful verification, the system can perform corresponding functions or rights permitted by the verification. In one embodiment, after a successful verification, operations on the mobile phone including, e.g., dialing a phone number and accessing the Internet can be performed.

As disclosed herein, with aids of icons, references can be made or added by the icons when the touch gestures are inputted. This can improve the convenience to the users during the inputting of touch gestures, especially when the flexibility of inputting touch gestures is limited.

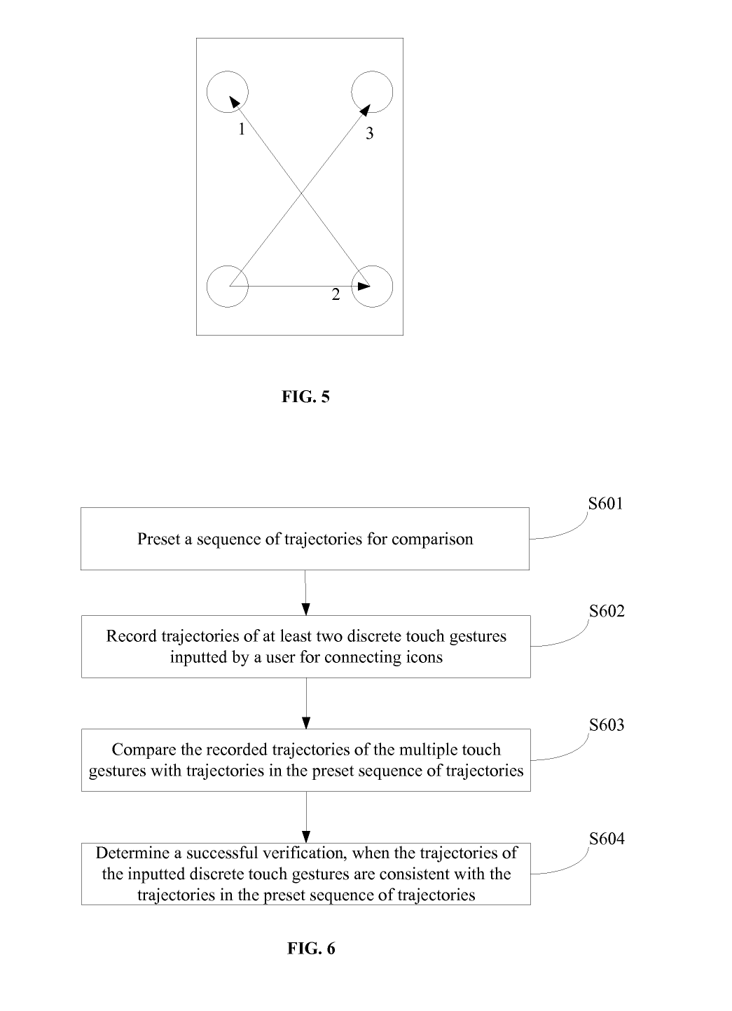

FIG. 6 depicts a flow diagram of another exemplary method for device verification in accordance with various disclosed embodiments. In Step S601, a sequence of trajectories is preset for comparison. The presetting of the sequence of trajectories for comparison can include, for example, (1) defining a trajectory for connecting icons; (2) selectively inputting the defined trajectory for connecting icons on certain orders to form a sequence of trajectories; (3) directly storing the sequence of trajectories, or storing the sequence of trajectories after a repeatedly inputting and a repeatedly comparison that confirms the sequences of trajectories inputted in both or the repeated times are consistent with each other.

For example, the defining of the trajectory for connecting icons can be demonstrated in the example shown in FIG. 5. Based on the four icons on the screen, about 12 touch gestures can be defined between two icons. Among those 12 touch gestures, a same trajectory (e.g., for connecting the same two icons) having a different direction can represent a different gesture.

In Step S602, trajectories of at least two (i.e., multiple) discrete touch gestures inputted by a user for connecting icons are recorded.

In Step S603, the recorded trajectories of the multiple touch gestures are compared with trajectories in a preset sequence of trajectories.

In Step S604, if the trajectories of the inputted discrete touch gestures are the same as or otherwise consistent with the trajectories in the preset sequence of trajectories, the verification is successful.

Steps S602-S604 can be the same as or similar to Steps S401-S403 as disclosed above in accordance with various embodiments.

As disclosed herein, the user can use a defined connection method between icons to input corresponding touch gestures. Such defining is convenient, and can provide the user with good visual guide.

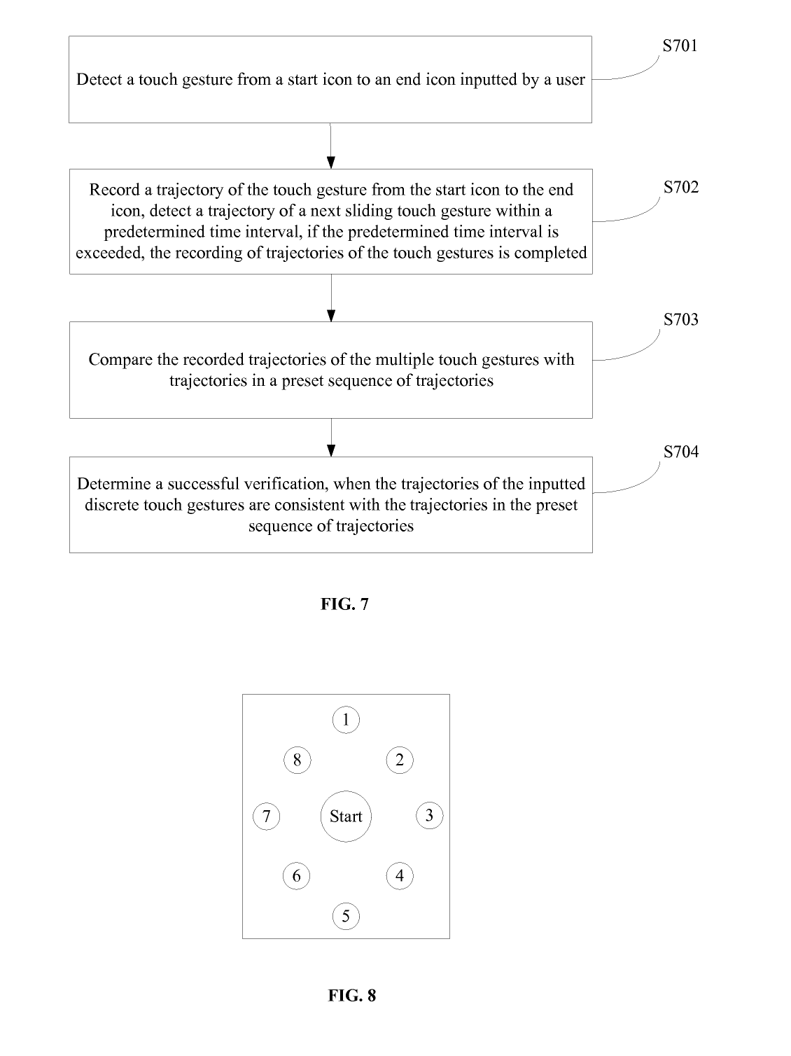

FIG. 7 depicts a flow diagram of another exemplary method for device verification in accordance with various disclosed embodiments.

In one embodiment, visible-icons provided with a touch screen of a device can include a start icon and multiple end icons. Further, on each one of the end icons, there can be a corresponding letter, number and/or other character. For example, referring to FIG. 8, on the position of each end icon, there can be a corresponding number (1, 2, 3, 4, 5, 6, 7, or 8) or a letter (a, b, c, d, e, f, g, or h). There can be eight methods for connections from the start icon to the end icons. A user can set the permutation and combination of the eight connecting methods.

Referring to FIG. 7, in Step S701, a touch gesture from the start icon to an end icon inputted by a user is detected.

In Step S702, a trajectory of the touch gesture from the start icon to an end icon inputted by the user is recorded. A trajectory of a next sliding touch gesture can be detected within a predetermined time interval. When the predetermined time interval is exceeded, the recording of the trajectory of the touch gesture can be completed.

In Step S703, the recorded trajectories of multiple touch gestures are compared with trajectories in a preset sequence of trajectories.

In Step S704, if the trajectories of the inputted discrete touch gestures are the same as or otherwise consistent with the trajectories in the preset sequence of trajectories, the verification is successful.

In one embodiment, in the verification interface as shown in FIG. 8, a touch gesture can be form by connecting the large center start icon with one of the surrounding end icons. The number of available touch gestures can be low. Combined with the symbols on the icons, it can be easier for the user to memorize and to use. The verification through simple sliding (touch gestures) can ensure security requirements and can allow convenient operations. For example, a password preset by the user can be 4321. Thus, four sliding touch gestures can be performed. The first gesture can form a trajectory from the start icon to the number 4, the second gesture can form a trajectory from the start icon to the number 3, and so on, until the four trajectories are completed, and the verification can be successful. The position of each number on the verification interface can be randomly generated each time. As long as the user remembers the password, the user can unlock the device according to the numbers displayed, but the gestures can be different every time.

FIG. 9 depicts a flow diagram of another exemplary method for device verification in accordance with various disclosed embodiments.

In Step S901, a touch gesture inputted by a user from starting touching the first icon to leaving a last-touched icon is detected.

In Step S902, a trajectory of the touch gesture inputted by the user from starting touching the first icon to leaving the last-touched icon is recorded. A trajectory of a next sliding touch gesture can be detected within a predetermined time interval. When the predetermined time interval is exceeded, the recording of trajectory of the touch gesture can be completed.

Specifically, for some users, touch gestures according to a sequence of trajectories can be formed by connecting more than two icons together, e.g., by connecting three or more icons. Therefore, under these circumstances, data (e.g., coordinates) need to be recorded for all passing points by a trajectory of a touch gesture inputted by a user from starting touching the first icon to leaving the last-touched icon.

In Step S903, the recorded trajectories of at least two (i.e., multiple) discrete touch gestures are compared with trajectories in a preset sequence of trajectories.

In step S904, if the trajectories of the inputted discrete touch gestures are the same as or otherwise consistent with the trajectories in the preset sequence of trajectories, the verification is successful.

As disclosed herein, a touch gesture inputted by the user each time is not limited by two icons. For example, a touch gesture can connect more than two, e.g., three or four or more icons. Thus, requirements of various users for various sequences of trajectories can be satisfied.

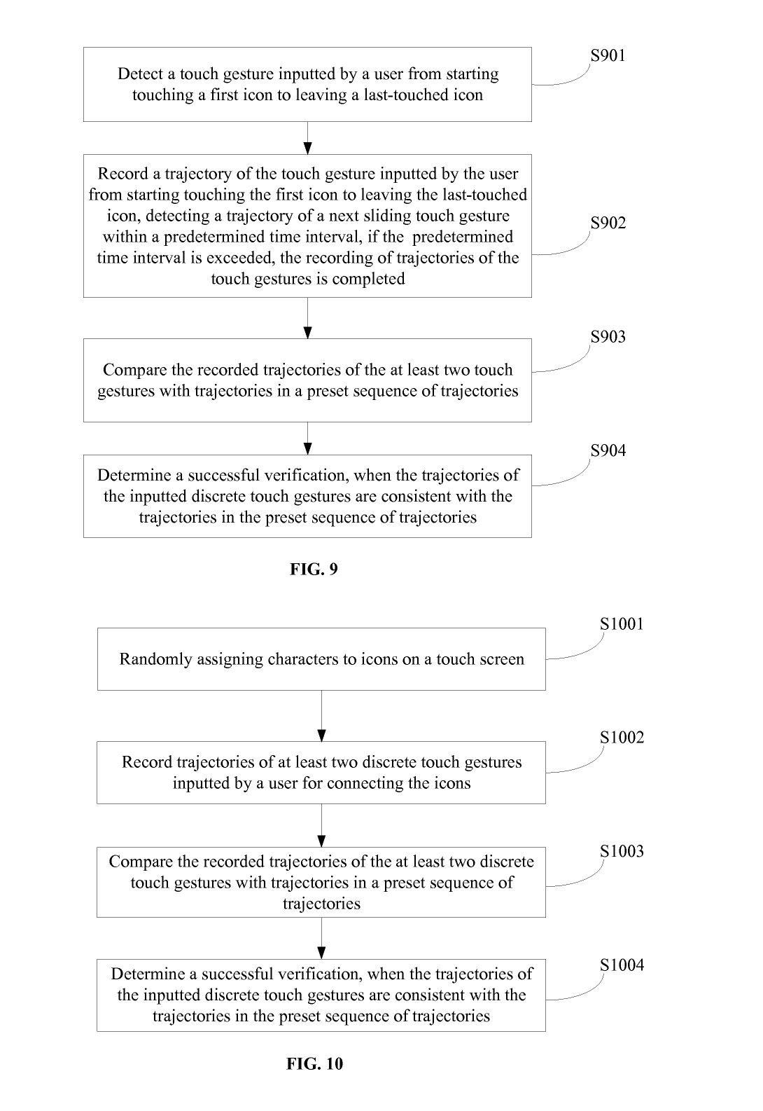

FIG. 10 depicts a flow diagram of another exemplary method for device verification in accordance with various disclosed embodiments. In one embodiment, icons on a touch screen can have corresponding characters thereon.

In Step S1001, characters are randomly assigned to the icons on a touch screen.

For example, in the verification interface shown in FIG. 8, during verification at each time, the characters on the icons can be randomly assigned. For example, an icon “1” can be located on an upper middle position during a previous verification. However, via a random assignment, the icon “1” may be in a position other than the upper middle position, e.g., in a lower middle position or other suitable positions.

In Step S1002, trajectories of at least two (i.e., multiple) discrete touch gestures inputted by a user for connecting icons are recorded. The user may need to adjust directions and positions of the inputted gestures, according to positions where the characters are randomly assigned.

In Step S1003, the recorded trajectories of the multiple touch gestures are compared with trajectories in a preset sequence of trajectories.

In Step S1004, if the trajectories of the inputted discrete touch gestures are the same as or otherwise consistent with the trajectories in the preset sequence of trajectories, the verification is successful.

This specific embodiment aims to further improve the security of device verification. In existing verification technology based on trajectories, touch marks from verification may remain on the touch screen. When a user performs device verification using the conventional touch marks, usual trajectories can be identified. In contrast, as disclosed herein, randomly-assigned characters can prevent such a situation, thus further improving device security.

FIG. 11 depicts a schematic of an exemplary apparatus for device verification in accordance with various disclosed embodiments. In one embodiment, a touch screen of a device is provided with multiple visible-icons. The exemplary apparatus for device verification can include a recording module 1101, a comparing module 1102, a sending module 1103 and/or an optional assigning module 1104.

The recording module 1101 is configured to record trajectories of at least two (i.e., multiple) discrete touch gestures inputted by a user for connecting icons.

The comparing module 1102 is configured to compare the recorded trajectories of the multiple touch gestures with trajectories in a preset sequence of trajectories.

The sending module 1103 is configured to determine that the verification is successful if the trajectories of the inputted discrete touch gestures are the same as or otherwise consistent with the preset sequence of trajectories and then send the successful verification to the system of the device to unlock the device.

In addition, to further improve device security, there can be corresponding characters on icons. Optionally, the assigning module 1104 is configured to randomly assign the characters to the icons on the touch screen.

In one embodiment, each module of the apparatus for device verification can be operated in a manner that is similar to or the same as corresponding step(s) in the method for device verification according to various disclosed embodiments, e.g., as depicted in FIGS. 1, 3, 4, 6, 7, 9, and/or 10.

In addition, various disclosed embodiments also provide a device with a touch screen having the apparatus for device verification according to various disclosed embodiments.

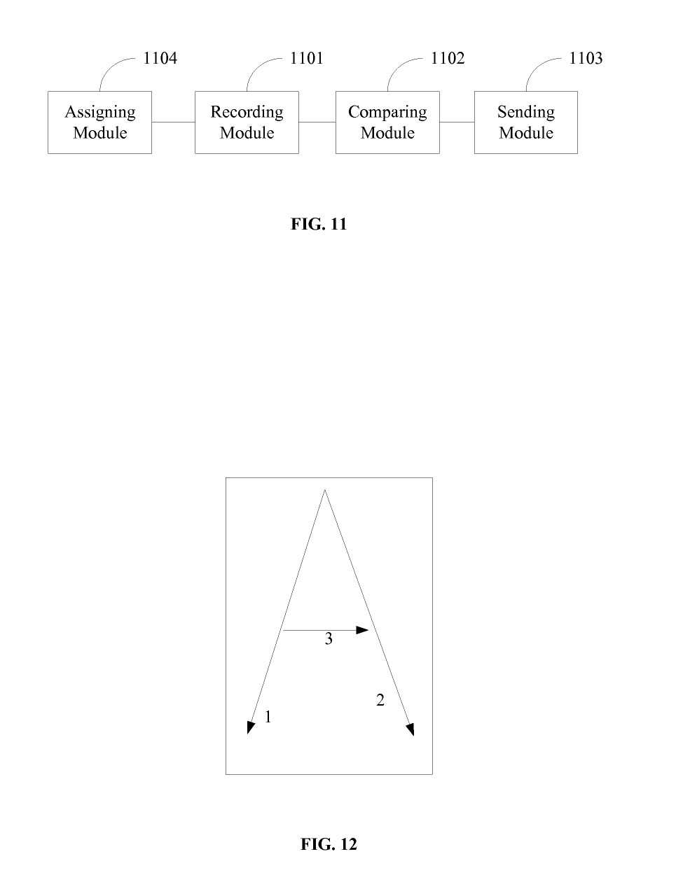

In one embodiment, trajectories of multiple discrete touch gestures can be set using familiar characters or patterns, which may allow an easy memorizing and/or operating during device verification. For example, referring to FIG. 12, trajectories of touch gestures can form a shape of letter “A”, wherein the stroke order can be consistent with the order of trajectories of the touch gestures. Trajectories set by familiar characters can be more convenient for users to memorize, thus improving operation efficiency. In addition, users' names (e.g., Chinese characters, such as a Chinese last name “ [symbol] ”, pronounced “ma”) can also be used for verification. In various embodiments, the method depicted in FIG. 12 may also be referred to as a dual verification. Thus, in addition to unlocking a device, the user may also enjoy the experience to sign a name on a device (e.g., a mobile phone).

According to various embodiments, a combination of touch gestures can be used as a password for device verification. Touch gestures can be used to replace traditional characters such as letters, which can ensure device security and convenient user operations at the same time. Icons can be provided on a touch screen, thus providing users with visual guide. Characters can be correspondingly provided with the icons for ease to be memorized and operated. Each time before a user inputs gestures, characters can be randomly assigned onto icons, so device security can be better ensured by preventing illegal users from verifying the device by touch marks.

According to various embodiments, touch gestures can be used as a part or a whole of a password, e.g., to replace combinations of 0-9, a-z and/or symbols in conventional passwords. Complexity of passwords can thus be reduced, while user's experience can be greatly improved.

According to various embodiments, gestures used to form passwords are not limited to sliding gestures. A variety of gestures can be used to form passwords according to the features of the devices. More types and larger number of gestures can be introduced according to the need of password complexity. In addition, one gesture with high complexity can also be used as a password.

The method of using a password of gestures can include the following three functions: (1) presetting a password; (2) verifying the password; and/or (3) changing the password.

A user needs to consecutively input an identical combination (i.e., sequence) of gestures at least twice. After detecting the user's input, the touch screen can transform the gestures into coordinates and send to the device system. The device system can decide whether the twicely-inputted gestures are consistent with each other (e.g., with a certain margin of error allowed). If they are consistent with each other, the password is successfully preset, and the sequence of gestures can be stored in the device system as a password with gestures.

When the user needs to verify the password of gestures, the device system can display a gesture inputting interface on the screen. The user can thus input a sequence of gestures on the screen in the same order as presetting the password. After detecting the user's input, the touch screen can transform the gestures into coordinates and send to the device system. The system can decide whether the inputted gestures are consistent with the gestures of the preset password (e.g., with a certain margin of error allowed). If they are consistent with each other, the verification is successful and the user can proceed to the next operation, e.g., to make a phone call.

The changing of the password can include two steps. In a first step, the password can be verified to verify the user identity. In a second step, after a successful verification, a new password of gestures can be preset.

In the apparatus and system according to various disclosed embodiments, each module is logically divided according to function, but is not limited to such a division so long as each module can realize the corresponding function. In addition, the specific name of each functional module is only intended for being distinguished from each other, and does not limit the scope of protection for the current disclosure.

In addition, in various embodiments, one or more or all of the steps in each of the exemplary methods herein can be accomplished using a program/software to instruct related hardware. Such program/software can be stored in a computer readable storage medium including, e.g., ROM/RAM, magnetic disk, optical disk, etc.

The embodiments disclosed herein are exemplary only. Other applications, advantages, alternations, modifications, or equivalents to the disclosed embodiments are obvious to those skilled in the art and are intended to be encompassed within the scope of the present disclosure.

What is claimed is:

1. A device verification method comprising:
recording, by an electronic device, trajectories of at least two discrete touch gestures inputted by a user;
comparing, by the electronic device, the recorded trajectories of the at least two discrete touch gestures with trajectories in a preset sequence of trajectories; and
determining, by the electronic device, a successful verification, when the trajectories of the inputted at least two discrete touch gestures are consistent with the trajectories in the preset sequence of trajectories.

2. The method of claim 1, wherein the comparing of the recorded trajectories of the discrete touch gestures with the trajectories the preset sequence of trajectories comprises:
comparing, one by one, the recorded trajectories of the at least two discrete touch gestures with the trajectories in the preset sequence of trajectories according to an order of the recording.

3. The method of claim 1, wherein the trajectories of the discrete touch gestures comprise characters, icons, or a combination thereof.

4. A device verification method having a plurality of icons on a touch screen of an electronic device, the method comprising:
recording trajectories of at least two discrete touch gestures inputted by a user for connecting icons;
comparing the recorded trajectories of the discrete touch gestures for connecting icons with trajectories in a preset sequence of trajectories; and
determining a successful verification when the trajectories of the inputted discrete touch gestures are consistent with trajectories in the preset sequence of trajectories.

5. The method of claim 4, further comprising presetting the preset sequence of trajectories for comparison by:
defining a trajectory for connecting icons;
sequentially inputting the defined trajectory to form a sequence of trajectories; and
storing the sequence of trajectories directly, or
storing the sequence of trajectories after a second sequential inputting of the trajectory for connecting icons to form a second sequence of trajectories, followed by a comparison to verify consistency between the formed sequence of trajectories and the second sequence of trajectories.

6. The method of claim 4, wherein the plurality of icons set on the touch screen of the electronic device comprise a start icon and a plurality of end icons, and wherein the recording of the trajectories of the at least two discrete touch gestures inputted by the user comprises:
detecting a touch gesture from the start icon to one end icon of the plurality of end icons inputted by the user;
recording a trajectory of the touch gesture inputted by the user from the start icon to the one end icon; and
detecting a trajectory of a next sliding touch gesture within a predetermined time interval, or
completing the recording of the trajectory of the touch gesture when the predetermined time interval is exceeded.

7. The method of claim 4, wherein the recording of the trajectories of the at least two discrete touch gestures for connecting icons inputted by the user comprises:
detecting a touch gesture inputted by the user from starting touching a first icon to leaving a last-touched icon;
recording a trajectory of the touch gesture inputted by the user from starting touching the first icon to leaving the last-touched icon, and
detecting a trajectory of a next sliding touch gesture within a predetermined time interval or
completing the recording of the trajectory of the touch gesture when the predetermined time interval is exceeded.

8. The method of claim 4, further comprising characters on the plurality of icons.

9. The method of claim 8, further comprising:
randomly assigning the characters to one or more of the plurality of icons on the touch screen, prior to the recording of the trajectories of the at least two discrete touch gestures for connecting icons inputted by the user.

10. A device verification apparatus having a plurality of icons on a touch screen of an electronic device, the apparatus comprising:
a recording module, configured to record trajectories of at least two discrete touch gestures inputted by a user for connecting icons;
a comparing module, configured to compare the recorded trajectories of the discrete touch gestures for connecting icons with trajectories in a preset sequence of trajectories; and
a sending module, configured to determine and send a successful verification to a system of the electronic device, when the trajectories of the inputted discrete touch gestures are consistent with the trajectories in the preset sequence of trajectories.

11. The apparatus of claim 10, wherein the plurality of icons set on the touch screen of the electronic device comprise a start icon and a plurality of end icons, and wherein the recording module is configured to:
detect a touch gesture from the start icon to one end icon of the plurality of end icons inputted by the user;
record a trajectory of the touch gesture inputted by the user from the start icon to the one end icon; and
detect a trajectory of a next sliding touch gesture within a predetermined time interval, or
complete the recording of the trajectory of the touch gesture when the predetermined time interval is exceeded.

12. The apparatus of claim 10, wherein the recording module is configured to:
detect a touch gesture inputted by the user from starting touching a first icon to leaving a last-touched icon;
record a trajectory of the touch gesture inputted by the user from starting touching the first icon to leaving the last-touched icon; and
detect a trajectory of a next sliding touch gesture within a predetermined time interval, or
complete the recording of the trajectory of the touch gesture when the predetermined time interval is exceeded.

13. The apparatus of claim 10, wherein characters are on the plurality of icons.

14. An electronic device comprising the electronic device having the touch screen comprising the apparatus of claim 10.

15. The method of claim 5, further comprising characters on the plurality of icons.

16. The method of claim 6, further comprising characters on the plurality of icons.

17. The method of claim 7, further comprising characters on the plurality of icons.
